(19) United States
(12) Patent Application Publication
(10) Pub. No.: US 2023/0229490 A1
(43) Pub. Date: Jul. 20, 2023

(54) CONTAINER LOAD BALANCING FOR HOSTS IN A DISTRIBUTED COMPUTING SYSTEM

(71) Applicant: VMware, Inc., Palo Alto, CA (US)

(72) Inventors: Alok Kumar Maurya, Pune (IN); Kalyan Maddipatla, Pune (IN)

(21) Appl. No.: 17/697,982

(22) Filed: Mar. 18, 2022

(30) Foreign Application Priority Data
Jan. 17, 2022 (IN) 202241002712

(51) Int. Cl. G06F 9/48; H04L 9/40

(52) U.S. Cl. CPC G06F 9/4856; H04L 63/0227

(57) ABSTRACT

The disclosure herein describes managing the migration of nodes between hosts in a distributed computing system. Container statistics data is received by a scheduler from a plurality of hosts, wherein the container statistics data includes data indicating quantities of containers on nodes of the plurality of hosts. A first host of the plurality of hosts that includes a quantity of containers on associated nodes that exceeds a container per host threshold is identified and an excess container quantity is calculated. At least one node of the first host is selected for migration. A second host is identified that has container capacity that meets or exceeds the quantity of containers on the selected at least one node. The selected at least one node is migrated to the second host, whereby the quantity of containers on nodes of the first host is reduced to less than the container per host threshold.

### RELATED APPLICATION

Benefit is claimed under 35 U.S.C. 119(a)-(d) to Foreign Application Serial No. 202241002712 filed in India entitled “CONTAINER LOAD BALANCING FOR HOSTS IN A DISTRIBUTED COMPUTING SYSTEM”, on Jan. 17, 2022, by VMware, Inc., which is herein incorporated in its entirety by reference for all purposes.

### BACKGROUND

Containers can run computing services and/or applications. Container-as-a-Service (CaaS) platforms (e.g., KUBERNETES) deployed on top of distributed computing systems (e.g., VMWARE VSPHERE, NSX-T) deploy containers and/or groups of containers (e.g., KUBERNETES Pods) inside nodes (e.g., virtual machines (VMs) or other virtual computing instances (VCIs)). Such platforms offer significant flexibility in enabling many different applications to be deployed and run throughout the distributed system. However, due to the dynamic nature of the deployed containers, the central controller and/or scheduler of some existing systems is unable to detect when a node is beyond its container capacity limit until after the node begins to heavily use processing and/or memory resources of the host. Further, the scheduler of the system is prone to migrate nodes between hosts in such a way that some hosts exceed container capacity limits. Exceeding such limits can impact the datapaths of the containers and such impacts can cascade throughout the system.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A computerized method for managing the migration of nodes between hosts in a distributed computing system is described. Container statistics data is received by a scheduler from a plurality of hosts of a distributed computing system, wherein the container statistics data includes data indicating quantities of containers on nodes of the plurality of hosts. A first host of the plurality of hosts that includes a quantity of containers on associated nodes that exceeds a container per host threshold is identified based on the received container statistics data and an excess container quantity is calculated based on the quantity of containers and the container per host threshold of the first host. At least one node of the first host is selected for migration, wherein a quantity of containers on the selected at least one node meets or exceeds the calculated excess container quantity. A second host of the plurality of hosts is identified that has container capacity that meets or exceeds the quantity of containers on the selected at least one node, wherein the container capacity of the second host is a difference between a container per host threshold of the second host and a quantity of containers on associated nodes of the second host. The selected at least one node of the first host is migrated to the second host, whereby the quantity of containers on nodes of the first host is reduced to less than the container per host threshold of the first host and the quantity of containers on nodes of the second host remains equal to or less than the container per host threshold of the second host.

### BRIEF DESCRIPTION OF THE DRAWINGS

The present description will be better understood from the following detailed description read in light of the accompanying drawings, wherein:

FIG. 1 is a block diagram illustrating an exemplary system architecture that is comprised of a set of compute hosts interconnected with each other and a set of storage nodes;

FIG. 2 is a block diagram illustrating an exemplary system for managing migration of nodes between hosts of a distributed computing system;

FIG. 3 is a block diagram illustrating an exemplary system for setting up a host to work with a scheduler for managing migration of nodes between hosts of a distributed computing system;

FIG. 4 is a sequence diagram illustrating an exemplary method for configuring a system for managing migration of nodes between hosts of a distributed computing system;

FIG. 5 is a sequence diagram illustrating an exemplary method for deploying nodes on hosts of a distributed computing system and distributing priority information to the nodes;

FIG. 6 is a sequence diagram illustrating an exemplary method for deploying containers and migrating nodes in a distributed computing system;

FIG. 7 is a flowchart illustrating an exemplary computerized method for managing the migration of nodes between hosts in a distributed computing system;

FIG. 8 is a flowchart illustrating an exemplary computerized method for tracking container statistics data on a host in a distributed computing system;

FIG. 9 is a flowchart illustrating an exemplary computerized method for migrating nodes between hosts in a distributed computing system based on priorities of the nodes; and

FIG. 10 illustrates an example computing apparatus as a functional block diagram.

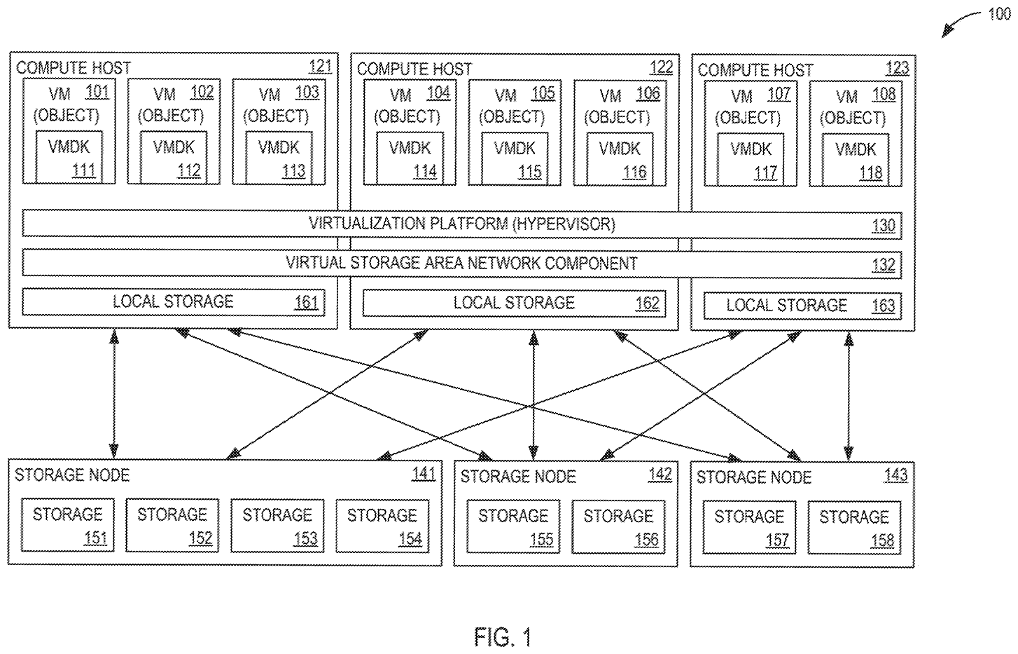

Corresponding reference characters indicate corresponding parts throughout the drawings. In FIGS. 1 to 10, the systems are illustrated as schematic drawings. The drawings may not be to scale.

### DETAILED DESCRIPTION

Aspects of the disclosure provide a computerized method and system for managing the migration of nodes between hosts in a distributed computing system. A container statistics agent deployed on each host of the system collects container statistics of each node on the host. These container statistics are sent by the container statistics agent to a centralized scheduler of the distributed computing system. The scheduler is configured to detect when hosts have excessive quantities of containers, and causes nodes of such hosts to be migrated to other hosts to balance the container load across the system. For instance, container statistics data is received by a scheduler from a plurality of hosts, including data indicating quantities of containers on nodes of the plurality of hosts. A first host that includes a quantity of containers that exceeds a container per host threshold is identified and an excess container quantity is calculated. At least one node of the first host is selected for migration based on the quantity of containers on the at least one node. Then, a second host is identified that has container capacity that meets or exceeds the quantity of containers on the selected node. The selected node is then migrated to the second host. In this manner, the quantity of containers on nodes of the first host is reduced to less than the container per host threshold.

The disclosure operates in an unconventional manner at least by executing the container statistics agent on each host to gather and route the container statistics data to the central scheduler of the system. The data provided by the container statistics agents enables the scheduler to monitor and analyze the distribution of containers throughout the hosts of the system and to initiate node migration upon detecting hosts that have exceeded a container per host threshold. This container statistics data pipeline from collection by the agent to analysis by the scheduler enables the system to react rapidly and efficiently to unbalanced container distribution. As a result, the negative impacts of hosts being overloaded, datapaths being negatively affected, or the like are reduced or even entirely avoided.

Further, the disclosure uses technical priority values (also referred to as “priority values”) of nodes to enable the central scheduler to prioritize migration of less crucial nodes over migration of more crucial nodes. Some nodes on the system, such as master nodes, can cause significant downtime or other negative effects to the system in the case of downtime due to migration, while other nodes can be migrated with insignificant effect on other parts of the system. By prioritizing the migration of the latter nodes over the former nodes, the nodes for which migration would cause greater negative effects are protected from being migrated unless necessary. The use of technical priority values in this manner enhances the performance of the distributed computing system and reduces downtime, slowdowns, or other issues that are noticeable to users of the system. In some examples, the technical priority values are based on technical performance requirements.

Additionally, or alternatively, the disclosure accounts for established firewall rules to maintain the security of nodes and/or hosts of the system. Firewall rules of the system are used when determining which nodes to migrate and/or which hosts to target with migration to make sure that secure access to, and control of, the nodes being migrated are preserved.

The disclosure enhances the efficiency of the distributed computing system by avoiding container distribution imbalances. Because such imbalances can cause downtime or other inefficiencies that ripple throughout the system (e.g., a slowdown in the use of an important resource on a host by one node or container can also prevent other nodes and/or containers from using that resource efficiently), the disclosure provides increased stability can positively affect all users of the system.

FIG. 1 is a block diagram illustrating a system architecture 100 that is comprised of a set of compute hosts 121-123 interconnected with each other and a set of storage nodes 141-143 according to an embodiment. In other examples, a different number of compute hosts and storage nodes may be used. Each compute host hosts multiple objects, which may be virtual machines (VMs), containers, pods or other groups of containers and/or applications, applications, or any compute entity that can consume storage. When objects are created, they are designated as global or local, and the designation is stored in an attribute. For example, compute host 121 hosts objects 101, 102, and 103; compute host 122 hosts objects 104, 105, and 106; and compute host 123 hosts objects 107 and 108. Some of objects 101-108 are local objects. In some examples, a single compute host may host 50, 100, or a different number of objects. Each object uses a virtual machine disk (VMDK), for example VMDKs 111-118 for each of objects 101-108, respectively. Other implementations using different formats are also possible. A virtualization platform 130, which includes hypervisor functionality at one or more of compute hosts 121, 122, and 123, manages objects 101-108.

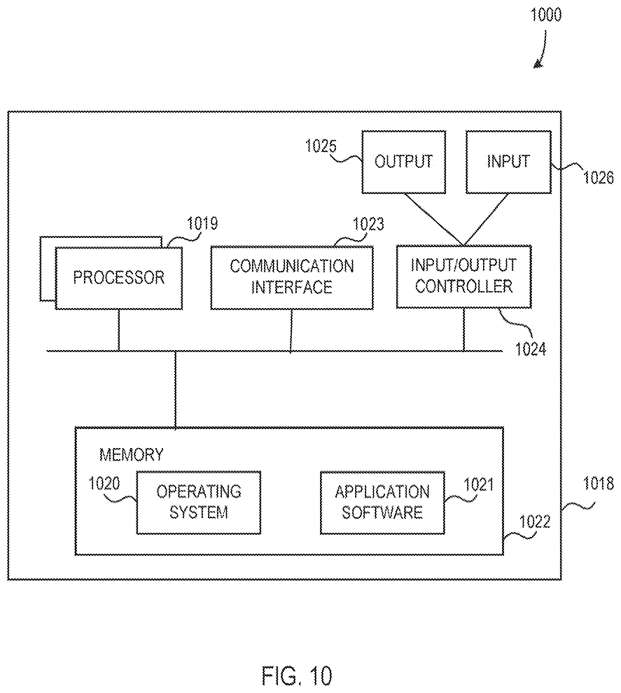

In some examples, various components of architecture 100, for example compute hosts 121, 122, and 123, and storage nodes 141, 142, and 143 are implemented using one or more computing apparatuses 1018 of FIG. 10.

Virtualization software that provides software-defined storage (SDS), by pooling storage nodes across a cluster, creates a distributed, shared data store, for example a storage area network (SAN). In some distributed arrangements, servers are distinguished as compute hosts (e.g., compute hosts 121, 122, and 123) and storage nodes (e.g., storage nodes 141, 142, and 143). Alternatively, or additionally, some arrangements include servers and/or other nodes that function as both compute hosts and storage nodes. Such an arrangement may be referred to as a hyperconverged infrastructure. Although a storage node may attach many storage devices (e.g., flash, solid state drives (SSDs), non-volatile memory express (NVMe), Persistent Memory (PMEM)) processing power may be limited beyond the ability to handle input/output (I/O) traffic.

Storage nodes 141-143 each include multiple physical storage components, which may include flash, solid state drives (SSDs), non-volatile memory express (NVMe), persistent memory (PMEM), and quad-level cell (QLC) storage solutions. For example, storage node 141 has storage 151, 152, 152, and 154; storage node 142 has storage 155 and 156; and storage node 143 has storage 157 and 158. In some examples a single storage node may include a different number of physical storage components. In the described examples, storage nodes 141-143 are treated as a SAN with a single global object, enabling any of objects 101-108 to write to and read from any of storage 151-158 using a virtual SAN component 132. Virtual SAN component 132 executes in compute hosts 121-123.

In some examples, compute hosts 121-123 each include a manifestation of virtualization platform 130 and virtual SAN component 132. Virtualization platform 130 manages the generating, operations, and clean-up of objects 101 and 102, including the migration or otherwise moving of object 101 from compute host 121 to another compute host, to become a migrated or moved object. Virtual SAN component 132 permits objects 101 and 102 to write incoming data from object 101 and incoming data from object 102 to storage nodes 141, 142, and/or 143, in part, by virtualizing the physical storage components of the storage nodes.

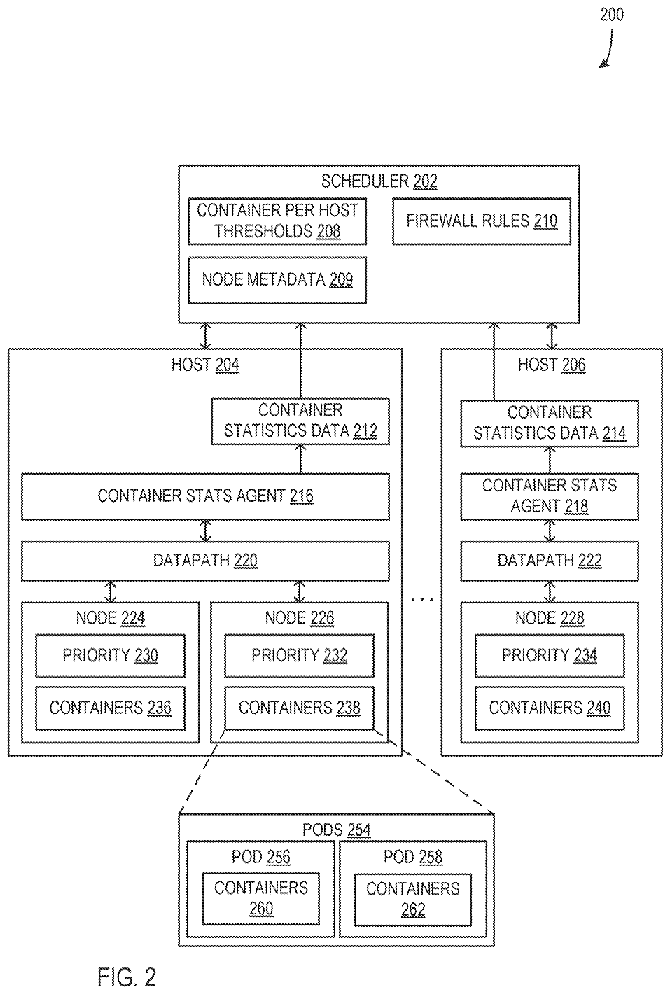

FIG. 2 is a block diagram illustrating a system 200 for managing migration of nodes 224-228 between hosts 204-206 of a distributed computing system. In some examples, the system 200 is part of a system architecture such as system architecture 100 of FIG. 1. The system 200 includes a scheduler 202 (e.g., a Distributed Resource Scheduler (DRS)) and hosts 204-206 (e.g., compute hosts 121-123). While two hosts 204-206 are illustrated, in other examples, more and/or different hosts are included in the system 200 without departing from the description.

The scheduler 202 includes hardware, firmware, and/or software configured to manage the resources of the hosts 204-206, including controlling the placement of nodes 224-228 on the hosts 204-206 and/or migration of nodes 224-228 between hosts 204-206. Further, the scheduler 202 is configured to monitor or otherwise track resource usage of the hosts 204-206, including monitoring the quantities of containers 236-240 (or other computing entities such as pods of containers) on hosts 204-206 and/or on individual nodes 224-226.

The hosts 204-206 include hardware, firmware, and/or software configured to host nodes 224-228 for performing computing tasks. In some examples, the hosts 204-206 are assigned hardware processing resources, hardware data storage resources, and/or other resources for use in hosting the nodes 224-228 and enabling those nodes to perform computing tasks.

The hosts 204-206 are configured to include container statistics (“stats”) agents 216-218. The container stats agent 216 is configured to be executed or otherwise run on a host 204 to collect container statistics data 212 from the datapath 220 of the host 204. The collected container statistics data 212 includes data indicating the quantity of containers that are on each node (e.g., the quantity of containers 236 on node 224) and/or data indicating the total quantity of containers on all nodes of the host 204 (e.g., the quantity of containers 236-238 on nodes 224-226 of the host 204). In some examples, the container stats agent 216 is configured to collect the container statistics data 212 by polling the datapath 220. Additionally, or alternatively, the polling of the datapath 220 is performed periodically and/or based on the occurrence of a triggering event.

The datapaths 220-222 include hardware, firmware, and/or software that is configured to route data to and from containers 236-240 on nodes 224-228 of the hosts 204-206. When a container 236 is added to a node 224 of a host 204, the datapath 220 is updated to include routing information for the container 236, such that when data intended for the container 236 is received from outside the host 204 or from a different component within the host 204, the routing information of the datapath 220 is used to route the data to the container 236. Further, the host 204 is configured to maintain the datapath 220 to keep the container routing information up to date. The container stats agent 216 uses this routing information to obtain quantities or counts of current containers on nodes and/or within entire hosts.

The hosts 204-206 are configured to host nodes 224-228. In some examples, the nodes 224-226 include VMs or other VCIs that execute or otherwise run service instances and/or other applications. The applications executed on the nodes 224-226 are contained within containers 236, 238, and 240 and each node is configured to run a plurality of applications contained in one or more containers. Further, in some examples, the containers 236-240 are each configured to contain one or more software applications and associated data. In such examples, in a container with data of multiple software applications, it should be understood that the multiple applications in the container are closely associated and/or at least one of the applications is dependent on another of the applications.

Additionally, or alternatively, in some examples, a node 224 is a VM upon which a set of containers 236 is deployed. Each of the containers 236 contains one or more applications that are being executed on the node 224 (e.g., using hardware, firmware, and/or software resources that are allocated to the node 224). The node 224 is hosted on the host 204 (e.g., the resources allocated to the node 224 are resources of the host 204) and interactions with the node 224 and/or containers 236 there on are routed through the host 204 and the associated datapath 220.

Further, in some examples, a node on a host of the system 200 is migrated to another host of the system 200 based on instructions from the scheduler 202 as described herein. The scheduler 202 receives the container statistics data 212-214 from hosts of the system 200, wherein the container statistics data 212-214 includes container quantity values associated with each node of the hosts and a total container quantity value of each host (e.g., a sum of all containers on the nodes of a host). Those container quantity values are compared to the container per host thresholds 208 to determine whether to migrate nodes between hosts and which nodes to migrate between hosts, as described herein. In an example, if the total container quantity value of host 204 exceeds the container per host threshold 208 by 30 containers and node 224 includes 35 containers 236, the scheduler 202 determines that node 224 should be migrated to another host. Further, the scheduler 202 determines that host 206 has a total container quantity value that is 50 less than the container per host threshold 208 and that the node 224 will otherwise fit on host 204. As a result, the scheduler 202 causes node 224 to be migrated from host 204 to host 206, thus reducing the quantity of containers on the host 204 to below the container per host threshold 208 and maintaining the quantity of containers of the host 206 below the container per host threshold 208.

In some examples, the scheduler 202 is configured to receive and store node metadata 209 of the nodes 224-228 of the system 200, including node location data (e.g., data indicating upon which host the node is hosted), node priority data (e.g., the priorities 230-234 as described below), and/or node content data (e.g., data indicating which containers and/or how many containers are on the node). The node metadata 209 is sent to the scheduler 202 from each host (e.g., as part of the container statistics data 212-214). The node metadata 209 stored on the scheduler 202 is updated periodically and/or based on triggering events (e.g., a node on a host is stopped or otherwise removed from the host or a new node is added to the host). In such examples, the node metadata 209 is used by the scheduler 202 to determine which node(s) to select for migration as well as how many nodes to select for migration. For instance, if a host 204 exceeds the container per host threshold 208 by 100 containers, the scheduler 202 analyzes the node metadata 209 of nodes on the host 204 to identify one or more nodes that have quantities of containers equal to or greater than 100 containers. Further, the container quantities of the nodes are used to select between nodes for migration. For instance, if the scheduler 202 identifies a first node that has 103 containers and a second node that has 200 containers, the scheduler 202 is configured to select the first node for migration in order to minimize the degree to which the operations of containers and the applications therein are affected by migration (e.g., interrupting the 103 containers on the first node instead of interrupting the 200 containers on the second node).

Further, in some examples, different hosts (e.g., host 204 and host 206) have different container per host thresholds 208 that are stored and used by the scheduler 202. In such examples, the thresholds 208 for each host 204-206 are based on the types and/or quantities of applications for which the host is configured, the party or entity that is using the host to run applications, the quantities and types of hardware resources that are allocated or otherwise available to the host, and/or for other reasons. Additionally, in some examples, the container per host thresholds 208 of the hosts 204-206 are dynamic and can be changed based on changes to the features of the hosts 204-206 and/or based on application of machine learning techniques to improve the performance or efficiency of the system.

Additionally, or alternatively, the container per host thresholds 208 are treated as soft limits, such that the thresholds 208 can be exceeded temporarily and/or slightly without the scheduler 202 causing nodes to be migrated. For instance, if the scheduler 202 determines that the host 204 exceeds its threshold 208, the scheduler 202 is configured to wait a period of time and then determine whether the host 204 still exceeds the threshold 208, If it does, the scheduler 202 initiates migration of nodes from the host 204. If it does not, the scheduler 202 does not initiate migration of nodes from host 204. Further, in some examples, the length of time that the scheduler 202 waits before initiating migration and/or the degree to which the thresholds 208 can be exceeded without the scheduler 202 initiating migration are determined and adjusted based on a feedback loop and/or machine learning techniques (e.g., learning the length of time after which exceeding the threshold 208 is indicative of negative impacts on the system due to container load imbalances rather than just being a transient event).

In some examples, the nodes 224, 226, and 228 are configured to include priorities 230, 232, and 234, respectively. Priorities 230-234 of nodes 224-228 are used to determine which nodes to migrate between hosts. The priorities of nodes are provided to the scheduler 202 (e.g., with the container statistics data 212-214) and the scheduler 202 selects nodes to be migrated by selecting nodes with lower priorities before selecting nodes with higher priorities. For example, the host 204 has exceeded the container per host threshold 208 and either the node 224 or the node 226 must be migrated to the host 206 to reduce the quantity of containers on the node 224 to below the container per host threshold 208. The node 224 has a priority 230 of ‘100’ and the node 226 has a priority 232 of ‘200’, where nodes with higher priority values are considered to be more important and/or considered to be more disruptive to migrate. Based on the priorities of the nodes 224 and 226, the scheduler 202 selects the node 224 for migration the host 206. In other examples, other priority types or conventions are used without departing from the description (e.g., nodes with lower priority values are considered more important and therefore are less likely to be selected for migration than nodes with higher priority values, such as a node with a priority value of 1 being considered top priority and a node with a priority value of 5 being considered lesser priority).

Further, in some examples, nodes 224-228 are assigned priorities when they are instantiated, created, and/or started. Such priorities are assigned based on the types of containers the node is configured to execute or perform, based on other processes for which the node is configured, and/or a node is assigned a default priority value automatically (e.g., such a default priority value is considered lower priority in comparison to other priorities that are assigned nodes for other reasons). Additionally, or alternatively, the priority of a node in the system 200 is changeable and it may change based on the node beginning to execute higher priority applications in its containers, resulting in an increased priority, for instance. In other examples, a node completes execution of a high priority application, and an associated container is removed, resulting in a decreased priority.

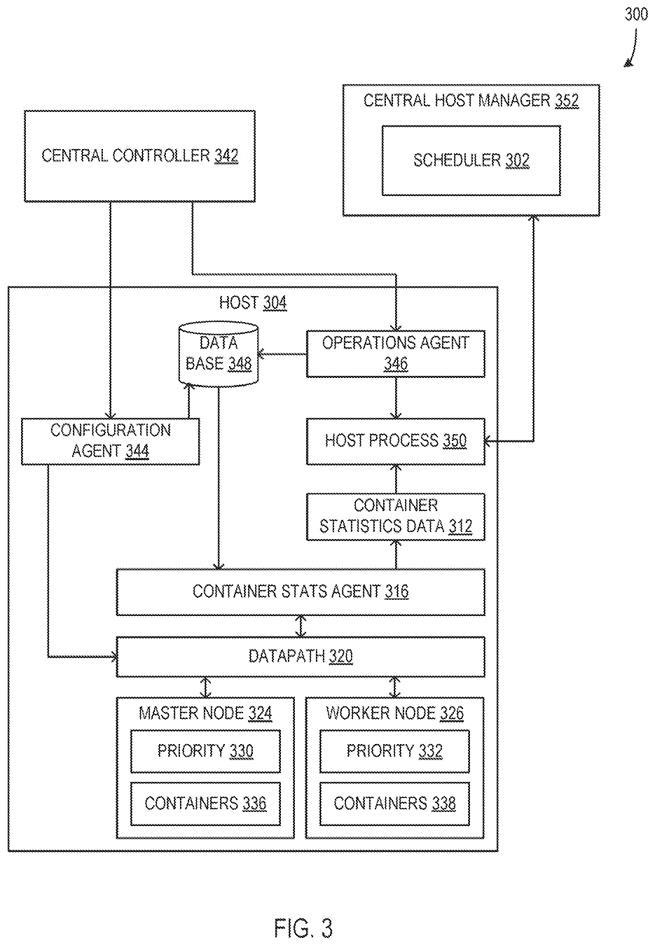

Additionally, or alternatively, priorities are assigned to clusters of nodes or other groupings of nodes (e.g., a priority value assigned to each node of a cluster that includes one or more master nodes and a plurality of worker nodes as described below with respect to FIG. 3). For example, a cluster of nodes is deployed on the system that is configured to perform a crucial operation or function for the system such that interruption of the nodes of the cluster should be avoided. To reduce the likelihood that any nodes in the cluster are interrupted to be migrated, a high priority value is assigned to all the nodes of the cluster, such that nodes on hosts with lower priority values are more likely to be migrated from those hosts as described herein.

In some examples, scheduler 202 is configured to select multiple lower priority nodes for migration to protect a higher priority node from migration. In an example, 50 containers must be migrated from host 204 to host 206. Node 224 has a high priority 230 and 55 containers 236. Node 226 and another similar node have lower priorities and they each have 30 containers. The scheduler 202 is configured to select both node 226 and the other similar node for migration to avoid migrating the single higher priority node 224. Alternatively, in other examples, the scheduler 202 is configured to prioritize efficient migration processes that minimize the total quantity of nodes being migrated, such that a single higher priority node is migrated before two or more lower priority nodes. Other methods of selecting nodes with priority values for migration are used in other examples without departing from the description.

In some examples, the containers 236-240 of the hosts 204-206 of the system 200 are organized and/or combined into ‘pods’ of containers (e.g., KUBERNETES Pods). For instance, in some examples, the containers 238 of node 226 are organized into pods 254, including a pod 256 that contains a set of containers 260 and a pod 258 that contains a set of containers 262. In these examples, pods are deployable units of computing that include a group of one or more containers. The containers of a pod have shared storage and network resources and the pod includes a specification for how to run the containers in the pod. In such examples, the containers of a pod are co-located, co-scheduled, and run in a shared context. Further, in some examples, a pod models an application-specific “logical host” in that the application containers in a pod are tightly coupled. In examples where the containers are organized into pods, the system 200 is configured to perform operations described herein with respect to the pods. For instance, the scheduler 202 is configured to receive and store pod per host thresholds in addition to or alternative to the container per host thresholds 208 and the node metadata 209 includes metadata associated the nodes, pods, and containers for each host (e.g., information that identifies the pods on each node and the containers within those pods).

Further, in some examples, the scheduler 202 is configured to manage the migration of nodes 224-228 between hosts 204-206 based on firewall rules 210. The firewall rules 210 allow and/or prevent types of data traffic on associated containers and/or nodes. In some examples, a firewall rules threshold is defined such that, when the quantity of firewall rules 210 associated with nodes and/or containers of a host exceed the firewall rules threshold, a node migration is performed by the scheduler 202 to reduce the quantity of firewall rules 210 associated with the host to a value equal to or below the firewall rules threshold. In such examples, firewall rule quantity data is provided to the scheduler 202 and hosts that include containers and/or nodes associated with quantities of firewall rules that exceed firewall rule thresholds are identified. Migration operations are performed on such hosts by the scheduler 202, such that nodes are migrated to other hosts to reduce the quantity of firewall rules of the identified hosts to below the firewall rule thresholds. Further, the hosts to which such nodes are migrated are selected or identified based on having firewall rules capacity (e.g., having a firewall rules threshold that exceeds the current quantity of firewall rules associated with the containers and/or nodes of the host) that enables the receiving hosts to receive the migrated nodes without exceeding the associated firewall rules thresholds. During such node migration operations, one or more nodes migrated from an identified host are moved to one or more hosts.

FIG. 3 is a block diagram illustrating a system 300 for setting up a host 304 to work with a scheduler 302 for managing migration of nodes 324-326 and associated containers 334-336 between hosts of a distributed computing system. In some examples, the system 300 is configured in an equivalent way as system 200 and it further includes multiple hosts as described above. The system 300 further includes a central controller 342 that is configured to deploy, configure, and/or otherwise create the host 304. For instance, the central controller 342 deploys the host 304 and communicates with the configuration agent 344 and operations agent 346 to include the container per host threshold (e.g., threshold 208) and/or the pod per host threshold in the database 348 of the host 304. Further, the central controller 342 enables a user or other entity to define a priority value for one or more nodes 324-326 of the host 304 on deployment and/or to update the priority values of the nodes 324-326 later. These priority values 330 and 332 are passed down by the host 304 to the master node 324 and the worker node 326, respectively. Additionally, or alternatively, default priority values that are all the same value are automatically passed to the nodes of the host if the priority values are otherwise not defined.

As described above with respect to FIG. 2, the container stats agent 316 is configured to poll the datapath 320 to track the quantities of containers and/or pods per node, the quantities of containers and/or pods per host, and associated firewall rules (e.g., including tracking of child container information of pods therein). The resulting container statistics data 312 is sent to a host process 350 of the host 304 on a periodic basis.

In some examples, the host process 350 is configured to receive the container statistics data 312 from the container stats agent 316 and to send the container statistics data 312 to the central host manager 352, which includes the scheduler 302. The central host manager 352 is configured to perform management operations of the distributed computing system and the scheduler 302 is at least configured to manage the migration of nodes between hosts as described herein to support those management operations. Additionally, or alternatively, the central host manager 352 is configured to receive container statistics data from many different hosts of the system and to consolidate the data into a single location to be processed by the scheduler 302, enabling the scheduler 302 to analyze the states of all the hosts when making determinations about node migration.

Further, as described above with respect to scheduler 202, the scheduler 302 is configured to determine the best hosts to select as targets of node migrations based on CPU and/or memory statistics of the hosts, on the available container space (e.g., based on the container per host thresholds), and on the priority values of the nodes being migrated. When the scheduler 302 makes such a determination, migration of a node or nodes from a host that exceeds its threshold limit to one or more hosts that have capacity for the migrating nodes is initiated.

In some examples, the nodes 324-326 of the host 304 include a master node 324 and a worker node 326. In such examples, groups of nodes form clusters (e.g., KUBERNETES clusters) in which there is one master node and one or more worker nodes. The master node 324 controls the state of the cluster (e.g., which applications are running on the corresponding containers). Further, the master node 324 is the origin for all task assignments and it coordinates cluster-level processes such as scheduling and scaling applications, maintaining the cluster's state, and implementing updates to the cluster. The worker nodes 326 run the applications of the cluster as directed by the master node 324. In such examples, it is often the case that a master node 324 has a higher priority value 330 than the priority value 332 of a worker node 326, such that the master node 324 is less likely to be interrupted and migrated to another host.

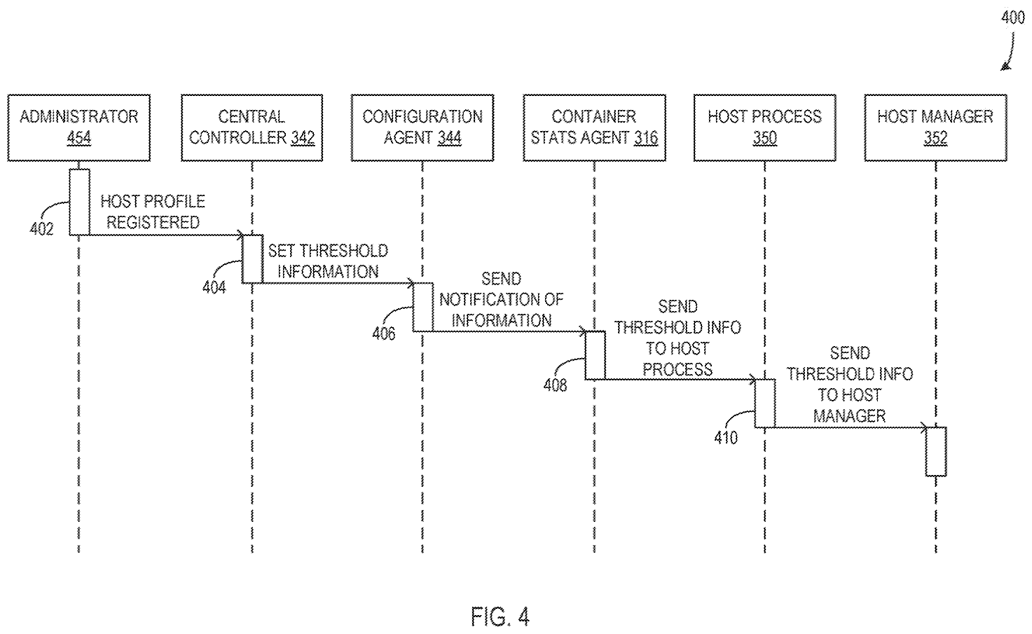

FIG. 4 is a sequence diagram illustrating a method 400 for configuring a system (e.g., a system 300 of FIG. 3) for managing migration of nodes (e.g., nodes 324-326) between hosts (e.g., hosts 304, 204, and/or 206) of a distributed computing system. In some examples, the method 400 is executed or otherwise performed by a system such as systems 200 and 300 of FIGS. 2 and 3, respectively.

At 402, an administrator 454 of the system registers a host profile with a central controller 342 of the system. In some examples, the host profile includes a container per host threshold and/or a pod per host threshold of the host. At 404, the central controller 342 sets the threshold information from the profile to the host using a configuration agent 344 of the host.

In some examples, the configuration agent 344 stores the received threshold information in a data structure of the host or otherwise makes the threshold information available to other components of the host, such as the container stats agent 316. In such cases, the configuration agent 344 sends a notification of the presence of the information to the container stats agent 316 at 406.

At 408, the container stats agent 316 accesses the threshold information based on receiving the notification from the configuration agent 344 and sends the accessed threshold information to the host process 350 of the host. At 410, the host process 350 receives the threshold information and forwards it to a host manager 352 of the system that is configured to manage the plurality of hosts of the system. The host manager 352 stores the threshold information for use by a scheduler in determining how to migrate nodes between hosts as described herein.

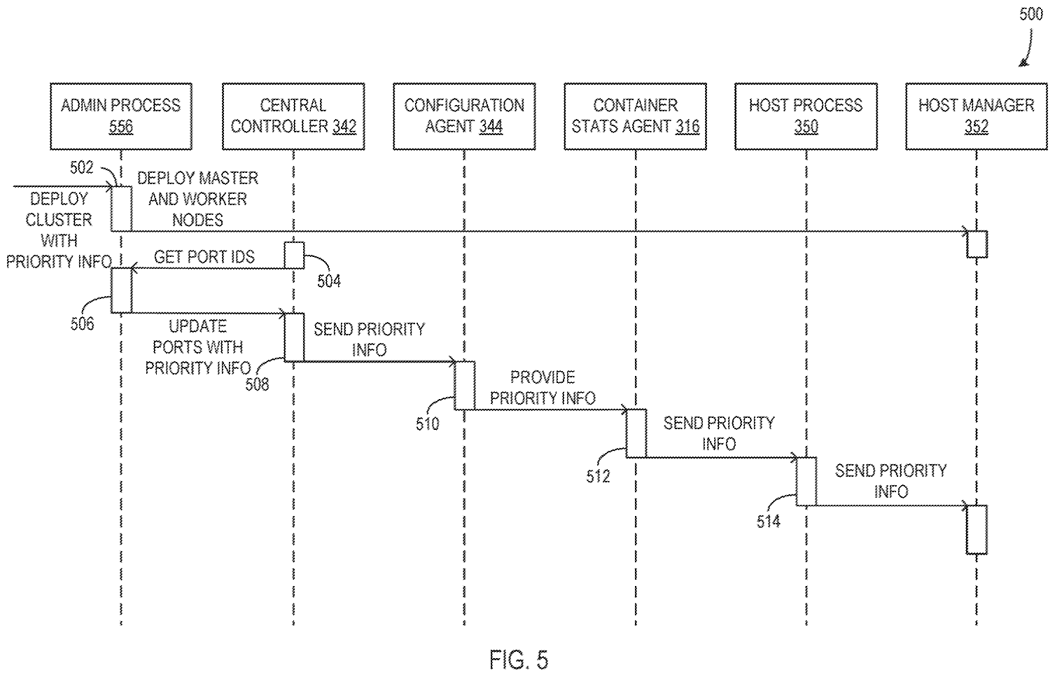

FIG. 5 is a sequence diagram illustrating a method 500 for deploying nodes on hosts of a distributed computing system and distributing priority information to the nodes. In some examples, the method 500 is executed or otherwise performed by a system such as systems 200 and 300 of FIGS. 2 and 3, respectively.

At 502, an admin process 556 of the system receives instructions to deploy a cluster of nodes with associated priority information and the associated master and worker nodes are deployed to the hosts of the system, including notifying the host manager 352 of the system about the nodes being deployed.

At 504, the central controller 342 gets port identifiers (IDs) of the deployed nodes from the admin process 556 and, at 506, the central controller 342 updates the port IDs of the nodes with associated priority information (e.g., mapping or otherwise associating each node port ID with the corresponding node priority value).

At 508, the central controller 342 sends the priority information, including the associated node IDs, to be stored on the corresponding hosts of the system by the configuration agents 344 of each host. The stored priority information is provided to the container stats agents 316 of each host via the storage data structure of the hosts at 510.

At 512, the container stats agents 316 of each host send the provided priority information to the corresponding host processes 350 of each host and, at 514, the priority information is forwarded by the host processes 350 to the host manager 352 of the system. In some examples, the priority information is used by a scheduler for determining which nodes to migrate as described herein.

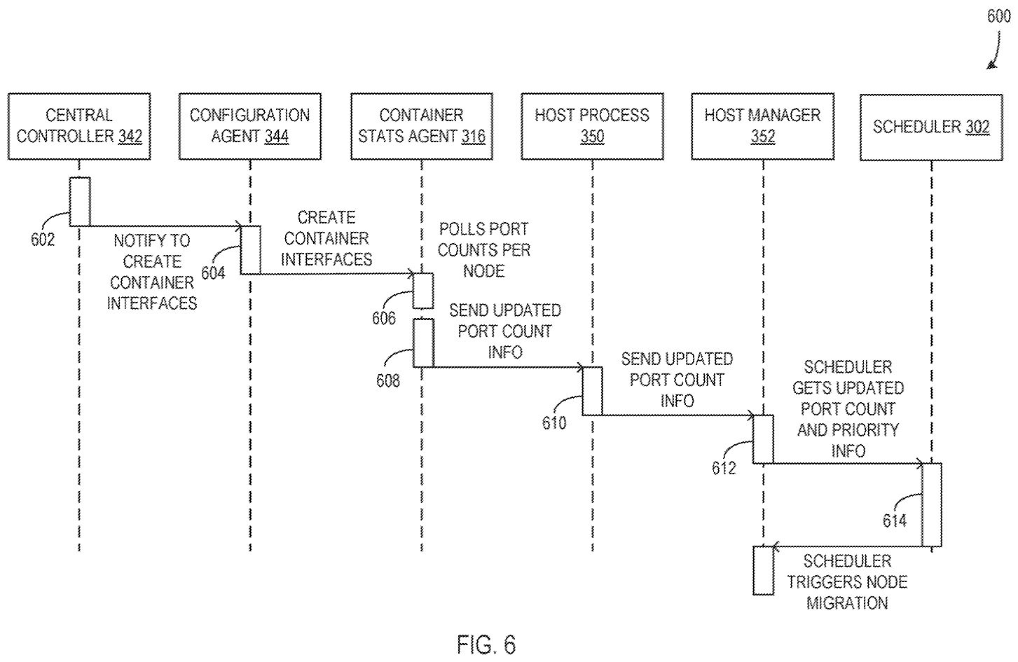

FIG. 6 is a sequence diagram illustrating a method 600 for deploying containers and migrating nodes in a distributed computing system. In some examples, the method 600 is executed or otherwise performed by a system such as systems 200 and 300 of FIGS. 2 and 3, respectively.

At 602, the central controller 342 notifies the configuration agents 344 of each host to create container interfaces for the nodes deployed thereon. At 604, based on the configuration agents 344 creates the container interfaces on the respective hosts.

At 606, the container stats agents 316 of the hosts poll the port counts per node of the hosts. In some examples, the previously obtained port IDs of the nodes are used. Further, the agents 316 count the containers on each node and the total containers on the respective hosts using these polled port counts. At 608, the container stats agents 316 send updated port count information to the host processes 350 which forward the updated port count information to the host manager 352 of the system at 610.

At 612, the host manager provides the scheduler 302 with the updated port count information and priority information that has been obtained previously (e.g., method 500 as described above). At 614, the scheduler 302 uses the provided information to trigger node migration between hosts of the system as described herein. In some examples, the triggered node migration instructions are provided back to the host manager 352 and/or another component of the host manager 352 that is configured to instruct hosts to perform node migration operations to send nodes to and/or receive nodes from other hosts of the system.

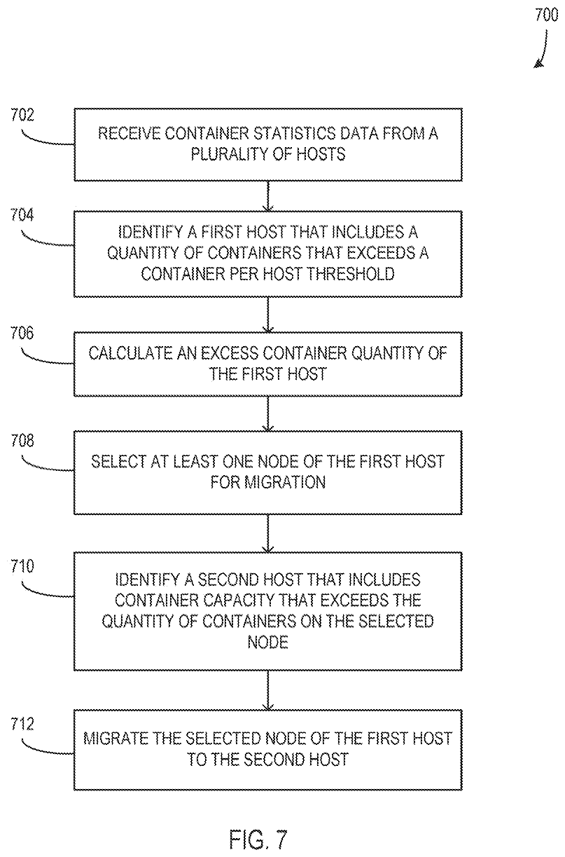

FIG. 7 is a flowchart illustrating a computerized method 700 for managing the migration of nodes between hosts in a distributed computing system. In some examples, the method 700 is executed or otherwise performed by a system such as systems 200 and 300 of FIGS. 2 and 3, respectively.

At 702, a scheduler (e.g., scheduler 202) receives container statistics data from a plurality of hosts. In some examples, the container statistics data is received from host processes of the hosts after being collected or otherwise obtained by container statistics agents on each of the hosts as described herein.

At 704, a first host that includes a quantity of containers that exceeds a container per host threshold is identified. In some examples, the quantity of containers of the first host is determined by combining the quantities of containers of each node of the first host. Further, the container per host threshold is defined as a general threshold that applies to multiple hosts of the system or as a threshold that is specific to the first host. In an example, a container per host threshold of the first host is defined to be 2000 containers and the current quantity of the containers that are on nodes hosted by the first host exceeds 2000.

At 706, an excess container quantity of the first host is calculated and based on the container per host threshold and the quantity of containers on the first host. At 708, based on the calculated excess container quantity, at least one node of the first host is selected for migration. In some examples, selecting the at least one node includes selecting one or more nodes that have a total container quantity that meets or exceeds the excess container quantity of the first host. For example, if the excess container quantity is 100, a first node that has 55 containers and a second node that has 50 containers are selected for migration, such that a total of 105 containers are migrated from the first host.

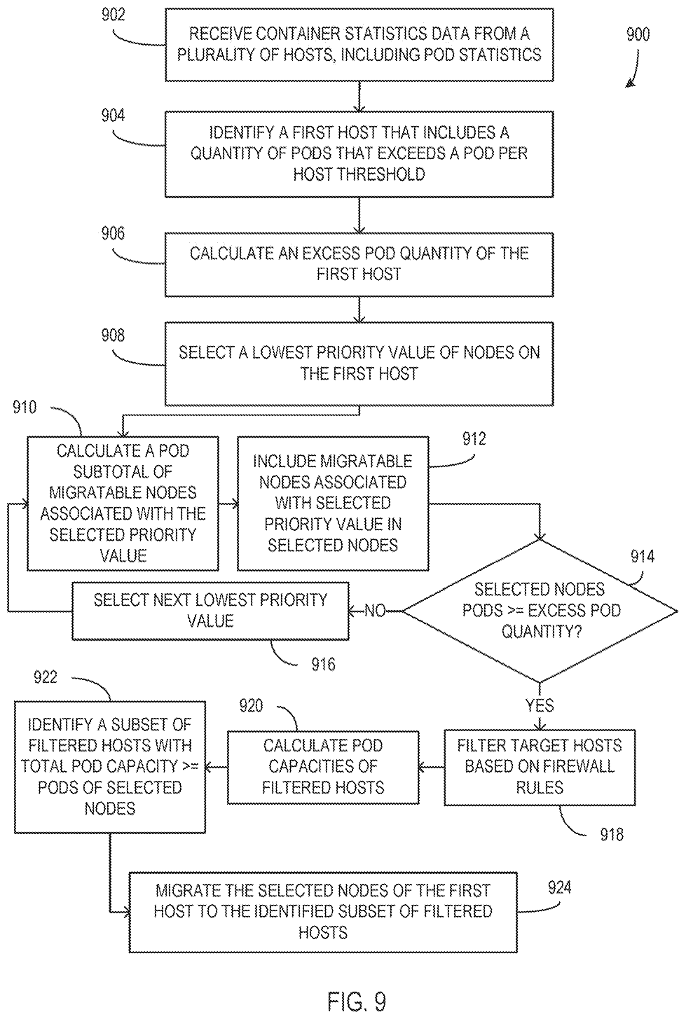

At 710, a second host is identified that includes container capacity that exceeds the quantity of containers on the selected at least one node to be migrated. Additionally, or alternatively, multiple hosts are selected as migration targets for the nodes to be migrated as described in greater detail below with respect to FIG. 9.

At 712, the selected at least one node of the first host is migrated to the second host. In some examples, migrating a node from the first host to the second host includes stopping the node from executing or performing operations, transferring the files and/or other data of the node from storage associated with the first host to storage associated with the second host, updating the routing information of the node being migrated in the first and second hosts and other routing components of the system, and/or starting the node to begin performing operations on the second host. In other examples, more, fewer, and/or different operations are performed to migrate a node without departing from the description.

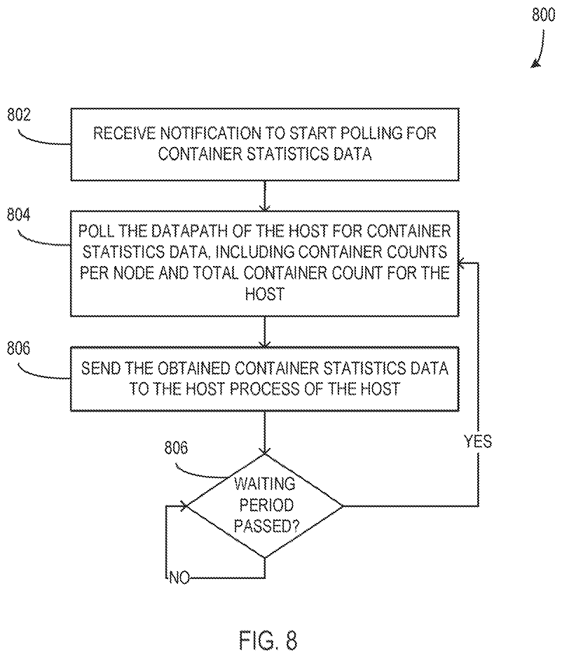

FIG. 8 is a flowchart illustrating a computerized method 800 for tracking container statistics data on a host in a distributed computing system. In some examples, the method 800 is executed or otherwise performed on a system such as systems 200 and 300 of FIGS. 2 and 3, respectively.

At 802, the container statistics agent of a host receives a notification to start polling for container statistics data. In some examples, the notification is received from a configuration agent or other component of the host.

At 804, the container statistics agent polls the datapath of the host for container statistics data, including container counts per node and total container count for the host. For example, the agent obtains the container counts per node for all nodes of the host and adds those counts together to obtain the total container count for the host. Additionally, or alternatively, the container statistics agent determines the current container per host threshold of the host, evaluates firewall rules that are applied by the host, and/or performs other operations as described herein without departing from the description.

Further, in some examples, polling the datapath for container statistics data includes identifying and/or counting port IDs associated with nodes of the host and/or containers on the nodes.

At 806, the obtained container statistics data is sent to the host process of the host. In some examples, the host process is configured to forward the container statistics data to a manager and/or scheduler component of the distributed computing system as described herein. Additionally, or alternatively, the container statistics data sends data associated with the container per host threshold of the host (e.g., an updated threshold value), the firewall rules that are applicable to the host, and/or other data or metadata collected by the container statistics agent.

At 806, if a waiting period is passed, the process returns to 804 to poll the datapath again. Alternatively, if the waiting period is not passed, the process continues to wait at 806. In some examples, the waiting period is a static period, while in other examples, the waiting period is dynamic, adjustable, and/or changeable. Further, in some examples, polling the datapath at 804 is triggered based on other reasons, such as events that occur on the host that cause the polling to be performed (e.g., new nodes are deployed to the host).

FIG. 9 is a flowchart illustrating a computerized method 900 for migrating nodes between hosts in a distributed computing system based on priorities of the nodes. In some examples, the method 900 is executed or otherwise performed on a system such as systems 200 and 300 of FIGS. 2 and 3, respectively.

At 902, container statistics data is received by a scheduler (e.g., scheduler 202) from a plurality of hosts, wherein the container statistics data include pod (e.g., KUBERNETES pods) statistics (e.g., counts of how many pods of containers are on anode). At 904, a first host that includes a quantity of pods that exceeds a pod per host threshold is identified and, at 906, an excess pod quantity is calculated for the first host. In some examples, the method 900 from 902-906 operates in an equivalent way as the method 800 from 802-806 as described above. One difference between the two is that method 900 uses pod-level statistics and method 800 uses container-level statistics, though other differences are possible. In other examples, method 900 uses container-level statistics and/or method 800 uses pod-level statistics without departing from the description.

At 908, the lowest priority value of nodes on the first host is selected and, at 910, a pod subtotal of migratable nodes associated with the selected priority value is calculated. The lowest priority value selected is the value that indicates associated nodes are the least important and/or that the associated nodes are the most likely to be migrated. The pod subtotal of migratable nodes includes a quantity of pods on nodes that are migratable and associated with the selected priority value. In an example where a host has nodes with priority values 1, 2, and 3 and the priority value 1 is considered the lowest priority value, the priority value 1 is selected, nodes with the priority value 1 are identified, and pods on those identified nodes are counted to determine the pod subtotal.

At 912, those migratable nodes associated with the selected priority value are included in the selected nodes (e.g., the nodes selected to be migrated from the first host).

At 914, if the quantity of pods on the selected nodes is less than the excess pod quantity of the first host, the process proceeds to 916. Alternatively, if the quantity of pods on the selected nodes is greater than or equal to the excess pod quantity of the first host, the process proceeds to 918.

Further, in some examples, if the quantity of pods of the selected nodes exceeds the excess pod quantity by an amount that is greater than a pod quantity of one or more of the selected nodes, some selected nodes are removed from the group of nodes to be migrated. Such node removal includes removing nodes associated with higher priority values before removing nodes associated with lower priority values. In an example, the quantity of pods of the selected nodes is 500, the excess pod quantity is 400, and there are two nodes in the selected nodes with fewer than 100 pods that are associated with different priority values. The node associated with the higher priority value is released from the group of nodes to be migrated while the node associated with the lower priority value is kept in the group.

At 916, the next lowest priority value of the nodes on the first host is selected and the process returns to 910 to calculate the pod subtotal of migratable nodes associated with that selected priority value. In this way, the nodes of different priority values are selected for migration in priority order, such that higher priority nodes are less likely to be migrated than lower priority nodes.

At 918, the hosts of the system that are potential targets for migration are filtered based on firewall rules. In some examples, firewall rules that limit hosts where the nodes to be migrated can be deployed are enforced by removing hosts upon which the nodes cannot be deployed from the group of potential target hosts.

At 920, the pod capacities of the filtered hosts are calculated and, at 922, a subset of filtered hosts with a total pod capacity that is greater than or equal to the quantity of pods of the selected nodes is identified. In some examples, identifying the subset of hosts to be migration targets includes identifying the smallest subset of filtered hosts, such that the migration process tends to split up the migrated nodes as little as possible. For example, if a single host has pod capacity for the selected nodes, that single host is identified as the target host for the migration of all the selected nodes. Alternatively, or additionally, other rules or methods of identifying the subset of filtered hosts are used without departing from the description.

At 924, the selected nodes of the first host are migrated to the identified subset of filtered hosts as described herein. In some examples, the migrated nodes are spread evenly between the subset of filtered hosts without exceeding the thresholds of those hosts. In other examples, other methods of dividing the migrated nodes between multiple target hosts are used without departing from the description.

In some examples, the method 900 includes selecting between worker nodes and master nodes to migrate, wherein the master nodes have higher priority values than the worker nodes such that the worker nodes are more likely to be migrated than the master nodes.

### Exemplary Operating Environment

The present disclosure is operable with a computing apparatus according to an embodiment as a functional block diagram 1000 in FIG. 10. In an example, components of a computing apparatus 1018 are implemented as a part of an electronic device according to one or more embodiments described in this specification. The computing apparatus 1018 comprises one or more processors 1019 which may be microprocessors, controllers, or any other suitable type of processors for processing computer executable instructions to control the operation of the electronic device. Alternatively, or in addition, the processor 1019 is any technology capable of executing logic or instructions, such as a hardcoded machine. In some examples, platform software comprising an operating system 1020 or any other suitable platform software is provided on the apparatus 1018 to enable application software 1021 to be executed on the device. In some examples, balancing container loads between hosts on a distributed computing system by migrating nodes as described herein is accomplished by software, hardware, and/or firmware.

In some examples, computer executable instructions are provided using any computer-readable media that are accessible by the computing apparatus 1018. Computer-readable media include, for example, computer storage media such as a memory 1022 and communications media. Computer storage media, such as a memory 1022, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium should not be interpreted to be a propagating signal per se. Propagated signals per se are not examples of computer storage media. Although the computer storage medium (the memory 1022) is shown within the computing apparatus 1018, it will be appreciated by a person skilled in the art, that, in some examples, the storage is distributed or located remotely and accessed via a network or other communication link (e.g., using a communication interface 1023).

Further, in some examples, the computing apparatus 1018 comprises an input/output controller 1024 configured to output information to one or more output devices 1025, for example a display or a speaker, which are separate from or integral to the electronic device. Additionally, or alternatively, the input/output controller 1024 is configured to receive and process an input from one or more input devices 1026, for example, a keyboard, a microphone, or a touchpad. In one example, the output device 1025 also acts as the input device. An example of such a device is a touch sensitive display. The input/output controller 1024 may also output data to devices other than the output device, e.g., a locally connected printing device. In some examples, a user provides input to the input device(s) 1026 and/or receive output from the output device(s) 1025.

The functionality described herein can be performed, at least in part, by one or more hardware logic components. According to an embodiment, the computing apparatus 1018 is configured by the program code when executed by the processor 1019 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, etc.) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example system comprises: at least one processor of a scheduler of a distributed computing system; and at least one memory comprising computer program code, the at least one memory and the computer program code configured to, with the at least one processor, cause the at least one processor to: receive container statistics data from a plurality of hosts of a distributed computing system, wherein the container statistics data includes data indicating quantities of containers on nodes of the plurality of hosts; identify a first host of the plurality of hosts that includes a quantity of containers on associated nodes that exceeds a container per host threshold of the first host based on the received container statistics data; calculate an excess container quantity of the first host based on the quantity of containers on the associated nodes of the first host and the container per host threshold of the first host; select at least one node of the first host for migration, wherein a quantity of containers on the selected at least one node meets or exceeds the calculated excess container quantity; identify a second host of the plurality of hosts that has container capacity that meets or exceeds the quantity of containers on the selected at least one node, wherein the container capacity of the second host is a difference between a container per host threshold of the second host and a quantity of containers on associated nodes of the second host; and migrate the selected at least one node of the first host to the second host, whereby the quantity of containers on nodes of the first host is reduced to less than the container per host threshold of the first host and the quantity of containers on nodes of the second host remains equal to or less than the container per host threshold of the second host.

An example computerized method comprises: receiving, by a processor of a scheduler, container statistics data from a plurality of hosts of a distributed computing system, wherein the container statistics data includes data indicating quantities of containers on nodes of the plurality of hosts; identifying, by the processor, a first host of the plurality of hosts that includes a quantity of containers on associated nodes that exceeds a container per host threshold of the first host based on the received container statistics data; calculating, by the processor, an excess container quantity of the first host based on the quantity of containers on the associated nodes of the first host and the container per host threshold of the first host; selecting, by the processor, at least one node of the first host for migration, wherein a quantity of containers on the selected at least one node meets or exceeds the calculated excess container quantity; identifying, by the processor, a second host of the plurality of hosts that has container capacity that meets or exceeds the quantity of containers on the selected at least one node, wherein the container capacity of the second host is a difference between a container per host threshold of the second host and a quantity of containers on associated nodes of the second host; and migrating, by the processor, the selected at least one node of the first host to the second host, whereby the quantity of containers on nodes of the first host is reduced to less than the container per host threshold of the first host and the quantity of containers on nodes of the second host remains equal to or less than the container per host threshold of the second host.

One or more computer storage media have computer-executable instructions that, upon execution by a processor, cause the processor to at least: receive container statistics data from a plurality of hosts of a distributed computing system, wherein the container statistics data includes data indicating quantities of containers on nodes of the plurality of hosts; identify a first host of the plurality of hosts that includes a quantity of containers on associated nodes that exceeds a container per host threshold of the first host based on the received container statistics data; calculate an excess container quantity of the first host based on the quantity of containers on the associated nodes of the first host and the container per host threshold of the first host; select at least one node of the first host for migration, wherein a quantity of containers on the selected at least one node meets or exceeds the calculated excess container quantity; identify a second host of the plurality of hosts that has container capacity that meets or exceeds the quantity of containers on the selected at least one node, wherein the container capacity of the second host is a difference between a container per host threshold of the second host and a quantity of containers on associated nodes of the second host; and migrate the selected at least one node of the first host to the second host, whereby the quantity of containers on nodes of the first host is reduced to less than the container per host threshold of the first host and the quantity of containers on nodes of the second host remains equal to or less than the container per host threshold of the second host.

Alternatively, or in addition to the other examples described herein, examples include any combination of the following:

wherein nodes of the first host include priority values; and wherein selecting the at least one node of the first host for migration includes prioritizing selection of nodes with a first priority value over nodes with a second priority value, wherein the first priority value indicates a lower priority than the second priority value.

wherein the nodes of the first host include a worker node including the first priority value and a master node including the second priority value, whereby the worker node is prioritized for migration over the master node.

wherein the containers on nodes of the plurality of hosts are organized into pods of containers; wherein the container statistics data from the plurality of hosts includes data indicating quantities of pods on nodes of the plurality of hosts; and wherein container per host thresholds of the first and second hosts are defined to be compared to quantities of pods on nodes of the first and second hosts respectively.

wherein the second host has container capacity that meets a quantity of containers on a first subset of the selected at least one node; wherein computerized method further comprises identifying, by the processor, a third host of the plurality of hosts that has container capacity that meets or exceeds the quantity of containers on a second subset of the selected at least one node, wherein the container capacity of the third host is a difference between a container per host threshold of the third host and a quantity of containers on associated nodes of the third host; and wherein the first subset of the selected at least one node is migrated from the first host to the second host and the second subset of the selected at least one node is migrated from the first host to the third host.

wherein the container statistics data includes firewall rule quantity data of the containers on nodes of the plurality of hosts; and wherein the computerized method further comprises: identifying a third host of the plurality of hosts that includes a quantity of firewall rules associated with containers on associated nodes that exceeds a firewall rules threshold of the third host based on the received container statistics data; identifying a fourth host of the plurality of hosts that has firewall rules capacity that meets or exceeds an excess quantity of firewall rules associated with containers on associated nodes of the third host that exceed the firewall rules threshold, wherein the firewall rules capacity of the fourth host is a difference between a firewall rules threshold of the fourth host and a quantity of firewall rules associated with containers on associated nodes of the fourth host; and migrating at least one node of the third host to the fourth host, whereby the quantity of firewall rules associated with containers on nodes of the third host is reduced to less than the firewall rules threshold of the third host and the quantity of firewall rules associated with containers on nodes of the fourth host remains equal to or less than the firewall rules threshold of the fourth host

wherein receiving the container statistics data from the plurality of hosts of a distributed computing system further includes: periodically receiving container statistics data from each host of the plurality of hosts, wherein the container statistics data from each host includes a container per host threshold of the host, container identifiers of the containers of the host obtained from a datapath of the host by a container statistics agent, node identifiers of the nodes hosted on the host, and mapping data indicating the containers located on each node hosted on the host; and consolidating the received container statistics data from each host into a single data structure for use in identifying the first host, selecting the at least one node for migration, and for identifying the second host.

Any range or device value given herein may be extended or altered without losing the effect sought, as will be apparent to the skilled person.

While no personally identifiable information is tracked by aspects of the disclosure, examples have been described with reference to data monitored and/or collected from the users. In some examples, notice is provided to the users of the collection of the data (e.g., via a dialog box or preference setting) and users are given the opportunity to give or deny consent for the monitoring and/or collection. The consent takes the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute an exemplary means for receiving, by a processor of a scheduler, container statistics data from a plurality of hosts of a distributed computing system, wherein the container statistics data includes data indicating quantities of containers on nodes of the plurality of hosts; exemplary means for identifying, by the processor, a first host of the plurality of hosts that includes a quantity of containers on associated nodes that exceeds a container per host threshold of the first host based on the received container statistics data; exemplary means for calculating, by the processor, an excess container quantity of the first host based on the quantity of containers on the associated nodes of the first host and the container per host threshold of the first host; exemplary means for selecting, by the processor, at least one node of the first host for migration, wherein a quantity of containers on the selected at least one node meets or exceeds the calculated excess container quantity; exemplary means for identifying, by the processor, a second host of the plurality of hosts that has container capacity that meets or exceeds the quantity of containers on the selected at least one node, wherein the container capacity of the second host is a difference between a container per host threshold of the second host and a quantity of containers on associated nodes of the second host; and exemplary means for migrating, by the processor, the selected at least one node of the first host to the second host, whereby the quantity of containers on nodes of the first host is reduced to less than the container per host threshold of the first host and the quantity of containers on nodes of the second host remains equal to or less than the container per host threshold of the second host.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
at least one processor of a scheduler of a distributed computing system; and
at least one memory comprising computer program code, the at least one memory and the computer program code configured to, with the at least one processor, cause the at least one processor to:
receive container statistics data from a plurality of hosts of a distributed computing system, wherein the container statistics data includes data indicating quantities of containers on nodes of the plurality of hosts;
identify a first host of the plurality of hosts that includes a quantity of containers on associated nodes that exceeds a container per host threshold of the first host based on the received container statistics data;
calculate an excess container quantity of the first host based on the quantity of containers on the associated nodes of the first host and the container per host threshold of the first host;
select at least one node of the first host for migration, wherein a quantity of containers on the selected at least one node meets or exceeds the calculated excess container quantity;
identify a second host of the plurality of hosts that has container capacity that meets or exceeds the quantity of containers on the selected at least one node, wherein the container capacity of the second host is a difference between a container per host threshold of the second host and a quantity of containers on associated nodes of the second host; and
migrate the selected at least one node of the first host to the second host, whereby the quantity of containers on nodes of the first host is reduced to less than the container per host threshold of the first host and the quantity of containers on nodes of the second host remains equal to or less than the container per host threshold of the second host.

2. The system of claim 1, wherein nodes of the first host include technical priority values; and
wherein selecting the at least one node of the first host for migration includes prioritizing selection of nodes with a first technical priority value over nodes with a second priority value, wherein the first technical priority value indicates a lower priority than the second technical priority value.

3. The system of claim 2, wherein the nodes of the first host include a worker node including the first technical priority value and a master node including the second technical priority value, whereby the worker node is prioritized for migration over the master node.

4. The system of claim 1, wherein the containers on nodes of the plurality of hosts are organized into pods of containers;
wherein the container statistics data from the plurality of hosts includes data indicating quantities of pods on nodes of the plurality of hosts; and
wherein container per host thresholds of the first and second hosts are defined to be compared to quantities of pods on nodes of the first and second hosts respectively.

5. The system of claim 1, wherein the second host has container capacity that meets a quantity of containers on a first subset of the selected at least one node; and
wherein the at least one memory and the computer program code are configured to, with the at least one processor, further cause the at least one processor to identify a third host of the plurality of hosts that has container capacity that meets or exceeds the quantity of containers on a second subset of the selected at least one node, wherein the container capacity of the third host is a difference between a container per host threshold of the third host and a quantity of containers on associated nodes of the third host; and
wherein the first subset of the selected at least one node is migrated from the first host to the second host, and the second subset of the selected at least one node is migrated from the first host to the third host.

6. The system of claim 1, wherein the container statistics data includes firewall rule quantity data of the containers on nodes of the plurality of hosts; and
wherein the at least one memory and the computer program code are configured to, with the at least one processor, further cause the at least one processor to:
identify a third host of the plurality of hosts that includes a quantity of firewall rules associated with containers on associated nodes that exceeds a firewall rules threshold of the third host based on the received container statistics data;
identify a fourth host of the plurality of hosts that has firewall rules capacity that meets or exceeds an excess quantity of firewall rules associated with containers on associated nodes of the third host that exceed the firewall rules threshold, wherein the firewall rules capacity of the fourth host is a difference between a firewall rules threshold of the fourth host and a quantity of firewall rules associated with containers on associated nodes of the fourth host; and
migrate at least one node of the third host to the fourth host, whereby the quantity of firewall rules associated with containers on nodes of the third host is reduced to less than the firewall rules threshold of the third host and the quantity of firewall rules associated with containers on nodes of the fourth host remains equal to or less than the firewall rules threshold of the fourth host.

7. The system of claim 1, wherein receiving the container statistics data from the plurality of hosts of a distributed computing system further includes:
periodically receiving container statistics data from each host of the plurality of hosts, wherein the container statistics data from each host includes a container per host threshold of the host, container identifiers of the containers of the host obtained from a datapath of the host by a container statistics agent, node identifiers of the nodes hosted on the host, and mapping data indicating the containers located on each node hosted on the host; and
consolidating the received container statistics data from each host into a single data structure for use in identifying the first host, selecting the at least one node for migration, and identifying the second host.

8. A computerized method comprising:
receiving, by a processor of a scheduler, container statistics data from a plurality of hosts of a distributed computing system, wherein the container statistics data includes data indicating quantities of containers on nodes of the plurality of hosts;
identifying, by the processor, a first host of the plurality of hosts that includes a quantity of containers on associated nodes that exceeds a container per host threshold of the first host based on the received container statistics data;
calculating, by the processor, an excess container quantity of the first host based on the quantity of containers on the associated nodes of the first host and the container per host threshold of the first host;
selecting, by the processor, at least one node of the first host for migration, wherein a quantity of containers on the selected at least one node meets or exceeds the calculated excess container quantity;
identifying, by the processor, a second host of the plurality of hosts that has container capacity that meets or exceeds the quantity of containers on the selected at least one node, wherein the container capacity of the second host is a difference between a container per host threshold of the second host and a quantity of containers on associated nodes of the second host; and
migrating, by the processor, the selected at least one node of the first host to the second host, whereby the quantity of containers on nodes of the first host is reduced to less than the container per host threshold of the first host and the quantity of containers on nodes of the second host remains equal to or less than the container per host threshold of the second host.

9. The computerized method of claim 8, wherein nodes of the first host include technical priority values; and
wherein selecting the at least one node of the first host for migration includes prioritizing selection of nodes with a first technical priority value over nodes with a second technical priority value, wherein the first technical priority value indicates a lower priority than the second technical priority value.

10. The computerized method of claim 9, wherein the nodes of the first host include a worker node including the first technical priority value and a master node including the second technical priority value, whereby the worker node is prioritized for migration over the master node.

11. The computerized method of claim 8, wherein the containers on nodes of the plurality of hosts are organized into pods of containers;
wherein the container statistics data from the plurality of hosts includes data indicating quantities of pods on nodes of the plurality of hosts; and
wherein container per host thresholds of the first and second hosts are defined to be compared to quantities of pods on nodes of the first and second hosts respectively.

12. The computerized method of claim 8, wherein the second host has container capacity that meets a quantity of containers on a first subset of the selected at least one node;
wherein computerized method further comprises identifying, by the processor, a third host of the plurality of hosts that has container capacity that meets or exceeds the quantity of containers on a second subset of the selected at least one node, wherein the container capacity of the third host is a difference between a container per host threshold of the third host and a quantity of containers on associated nodes of the third host; and
wherein the first subset of the selected at least one node is migrated from the first host to the second host and the second subset of the selected at least one node is migrated from the first host to the third host.

13. The computerized method of claim 8, wherein the container statistics data includes firewall rule quantity data of the containers on nodes of the plurality of hosts; and
wherein the computerized method further comprises:
identifying a third host of the plurality of hosts that includes a quantity of firewall rules associated with containers on associated nodes that exceeds a firewall rules threshold of the third host based on the received container statistics data;
identifying a fourth host of the plurality of hosts that has firewall rules capacity that meets or exceeds an excess quantity of firewall rules associated with containers on associated nodes of the third host that exceed the firewall rules threshold, wherein the firewall rules capacity of the fourth host is a difference between a firewall rules threshold of the fourth host and a quantity of firewall rules associated with containers on associated nodes of the fourth host; and
migrating at least one node of the third host to the fourth host, whereby the quantity of firewall rules associated with containers on nodes of the third host is reduced to less than the firewall rules threshold of the third host and the quantity of firewall rules associated with containers on nodes of the fourth host remains equal to or less than the firewall rules threshold of the fourth host.

14. The computerized method of claim 8, wherein receiving the container statistics data from the plurality of hosts of a distributed computing system further includes:
periodically receiving container statistics data from each host of the plurality of hosts, wherein the container statistics data from each host includes a container per host threshold of the host, container identifiers of the containers of the host obtained from a datapath of the host by a container statistics agent, node identifiers of the nodes hosted on the host, and mapping data indicating the containers located on each node hosted on the host; and
consolidating the received container statistics data from each host into a single data structure for use in identifying the first host, selecting the at least one node for migration, and for identifying the second host.

15. One or more computer storage media having computer-executable instructions that, upon execution by a processor, cause the processor to at least:
receive container statistics data from a plurality of hosts of a distributed computing system, wherein the container statistics data includes data indicating quantities of containers on nodes of the plurality of hosts;
identify a first host of the plurality of hosts that includes a quantity of containers on associated nodes that exceeds a container per host threshold of the first host based on the received container statistics data;
calculate an excess container quantity of the first host based on the quantity of containers on the associated nodes of the first host and the container per host threshold of the first host;
select at least one node of the first host for migration, wherein a quantity of containers on the selected at least one node meets or exceeds the calculated excess container quantity;
identify a second host of the plurality of hosts that has container capacity that meets or exceeds the quantity of containers on the selected at least one node, wherein the container capacity of the second host is a difference between a container per host threshold of the second host and a quantity of containers on associated nodes of the second host; and
migrate the selected at least one node of the first host to the second host, whereby the quantity of containers on nodes of the first host is reduced to less than the container per host threshold of the first host and the quantity of containers on nodes of the second host remains equal to or less than the container per host threshold of the second host.

16. The one or more computer storage media of claim 15, wherein nodes of the first host include technical priority values; and
wherein selecting the at least one node of the first host for migration includes prioritizing selection of nodes with a first technical priority value over nodes with a second technical priority value, wherein the first technical priority value indicates a lower priority than the second technical priority value.

17. The one or more computer storage media of claim 16, wherein the nodes of the first host include a worker node including the first technical priority value and a master node including the second technical priority value, whereby the worker node is prioritized for migration over the master node.

18. The one or more computer storage media of claim 15, wherein the containers on nodes of the plurality of hosts are organized into pods of containers;
wherein the container statistics data from the plurality of hosts includes data indicating quantities of pods on nodes of the plurality of hosts; and
wherein container per host thresholds of the first and second hosts are defined to be compared to quantities of pods on nodes of the first and second hosts respectively.

19. The one or more computer storage media of claim 15, wherein the second host has container capacity that meets a quantity of containers on a first subset of the selected at least one node; and
wherein the computer-executable instructions, upon execution by a processor, further cause the processor to at least identify a third host of the plurality of hosts that has container capacity that meets or exceeds the quantity of containers on a second subset of the selected at least one node, wherein the container capacity of the third host is a difference between a container per host threshold of the third host and a quantity of containers on associated nodes of the third host; and
wherein the first subset of the selected at least one node is migrated from the first host to the second host and the second subset of the selected at least one node is migrated from the first host to the third host.

20. The one or more computer storage media of claim 15, wherein receiving the container statistics data from the plurality of hosts of a distributed computing system further includes:
periodically receiving container statistics data from each host of the plurality of hosts, wherein the container statistics data from each host includes a container per host threshold of the host, container identifiers of the containers of the host obtained from a datapath of the host by a container statistics agent, node identifiers of the nodes hosted on the host, and mapping data indicating the containers located on each node hosted on the host; and
consolidating the received container statistics data from each host into a single data structure for use in identifying the first host, selecting the at least one node for migration, and for identifying the second host.
